(19) United States
(12) Patent Application Publication
(10) Pub. No.: US 2018/0288055 A1
(43) Pub. Date: Oct. 4, 2018

(54) DEVICE FOR CONTROLLING POWER DISTIBUTION TO DISTRIBITION LINES

(71) Applicant: Hanmi E&C Inc., Seoul (KR)

(72) Inventors: Soo Young JUNG, Seoul (KR); Young Hyun KIM, Incheon (KR); Kyeom Ho SONG, Seoul (KR); Sang Woo LEE, Seongnam-si (KR)

(21) Appl. No.: 15/938,387

(22) Filed: Mar. 28, 2018

(30) Foreign Application Priority Data
Mar. 28, 2017 (KR) 10-2017-0039492

(51) Int. Cl. H04L 29/06; H04L 29/08; H02J 13/00

(52) U.S. Cl. CPC H04L 63/10; H04L 67/12; H04L 2463/082; H02J 13/0079; H04L 63/08

(57) ABSTRACT

The present invention relates to a device for controlling power distribution to distribution lines in a distribution technology field. More particularly, the present invention relates an improved device for controlling power distribution to distribution lines for reinforcing security of Internet Of Things (IoT) by coupling a security chip, an security chip, an IoT security terminal, an IoT key distribution server, and a security application with each other upon smart metering using the IoT as a part of a smart grid to prevent unauthorized access and for efficiently controlling power distribution to distribution lines using metering information according to smart metering.

### BACKGROUND OF THE INVENTION

### Field of the Invention

The present invention relates to a device for controlling power distribution to distribution lines in a distribution technology field. More particularly, the present invention relates to an improved device for controlling power distribution to distribution lines for reinforcing security of Internet Of Things (IoT) by coupling a security chip, an IoT security terminal, an IoT key distribution server, and a security application with each other upon smart metering using the IoT as a part of a smart grid to prevent unauthorized access and for efficiently controlling power distribution to distribution lines using metering information according to smart metering.

### Related Art

A smart grid means a network for optimizing intelligent power energy efficiency by combining information technology with an conventional unidirectional power network achieved by power generation-power transmission-power distribution-sale steps to bidirectionally exchange real time information by a power provider and a consumer

A basic concept of the smart grid is to efficiently operate an overall power system like one body through bidirectionally sharing information by connecting a power plant, a transmission/distribution facility, and power consumers with each other.

Using the above, a power provider may flexibly control a supply amount by recognizing a power use situation in real time. The power consumer may control a use time and a consumption amount avoiding a time period with expensive cost by recognizing a power consumption situation in real time. Electricity such as electric energy of solar power generation, a fuel cell, or an electric vehicle produced from a home may be sold.

Further, since a smart grid which is an intelligent power network is operated by an automatic control system, the smart grid detects failure factors to minimize blackout, and is converted into a distribution type power system connecting various power providers and consumers with each other unlike an existing power system so that utilization of renewable energy of power generation having a limitation of irregular power production according to an amount of wind and an amount of sunlight is increased.

If the utilization of the renewable energy is increased, it is expected that a thermal power plant is replaced so that green gas and pollutants may be reduced to solve an environment problem.

In this manner, since the smart grid has many advantages, a plurality of countries around the world has promoted various businesses for configuring a next generation power network. To this end, various devices applied to a smart grid have been developed.

A smart meter is a constituent element essentially necessary to recognize a power use situation in real time by the smart grid. The smart meter is an electronic electric meter which allows a user to know a hourly rate using a function of measuring a hourly usage to transmit corresponding information, may check a consumption amount of power in real time, and may perform bidirectional communication between a power provider and users as compared with an existing power meter so that the power provider and the users may reduce a metering cost and save energy.

FIG. 1 is a block diagram schematically showing a smart grid system according to the related art.

The smart meter 10 measures consumption amounts of respective power consumption devices to transmit the measured metering data to a central server 50 of a power management center for integrally managing a consumption amount through a smart box 30.

Here, the smart box 30 may collect metering data provided from the smart meter 10 to transmit the collected metering data to the central server 50 of the power management center directly, or may store and analyze the collected metering data to transmit the stored metering data and analyzed information to the central server 50 of the power management center when necessary.

Further, the smart box may be configured as a multi-layered network architecture by smart boxes 30b and 30c of a lower layer and a smart box 30a of an upper layer. In addition, the smart meter may include smart meters 10b and 10c of a lower layer and a smart meter 10a of an upper layer. The smart meter 10a of an upper layer may be configured by a multi-layered network architecture for performing a function of measuring a consumption amount of power to acquire metering data and a function of collecting metering data of smart meters 10b and 10c to transmit the collected metering data to the smart box 30d.

Since the smart grid system configured by various network architectures as described above transmits the metering data from smart meters 10, 10a, 10b, 10c which are dispersed at each zone to the central server 50 of a power management center through smart boxes 30, 30a, 30b , 30c, 30d connected with the smart meter and receives and manages data information from many smart meters from one central server, the capacity of the central server 50 should be large and simultaneous load applied to the central server 50 is increased so that a problem may occur in processing all data.

In order to receive, control, and manage different types of metering data from different type smart meters, since there is a need to configure a network suited to each type, a platform and a server for supporting the network net, it is difficult to expand the system so that a cost is increased.

In order to solve the above problem, a following related art was disclosed.

As one part of a security reinforcing policy, a smart meter technology requires a security reinforcement related to an IoT so that there appeared a demand to supplement the security reinforcement.

In particular, North America and Europe have actively been carrying out a smart distribution line business using a smart meter, and has found a solution capable of convert an existing distribution line into a smart distribution line. Accordingly, North America and Europe have been making efforts to couple a facility management and operation through various sensors with the IoT.

However, there is a limitation that it is difficult to ensure stability only by security of software.

A cloud based smart grid system and a smart metering method using the same is disclosed in Korean Patent No. 10-1522175 (May 15, 2015).

### SUMMARY OF THE INVENTION

The present invention provides a device for controlling power distribution to distribution lines to prevent unauthorized access by reinforcing security of Internet of things (IoT) upon smart metering using the IoT as a part of a smart grid and for efficiently controlling power distribution to distribution lines using metering information according to smart metering.

In particular, the present invention provides a device for controlling power distribution to distribution lines which fundamentally blocks connection of a terminal by mounting a security chip including a hardware copy protection function on an individual terminal, thereby fundamentally blocking connection of a terminal which is not mounted with a security chip, and allowing only authorized terminals to connect through authentication, and allowing a net manager, a facility manager, or authorized users to use through universal 2nd factor (two factor) authentication.

A device for controlling power distribution to distribution lines, the device including: a distributed cloud server for receiving metering data from at least one smart meter and at least one smart meter distributed to a preset zone to collect and store power information, and for controlling and managing the smart meter and the smart box; and a central cloud server for classifying a plurality of smart meters and a plurality of smart meters into a group by zone according to an installation zone of the smart meters and the smart boxes to allocate the distributed cloud server to the group by zone, for registering, controlling, and managing the smart meters and the smart boxes in connection with the distributed cloud server, for analyzing the power information of the distributed cloud server to provide the power information and an analysis result to a remote access terminal, and for receiving a control signal with respect to the smart meter or the smart box from the remote access terminal to control the smart meter or the smart box through a distributed cloud server for managing a smart meter or a smart box which is a control target,

wherein a security chip is mounted in the remote access terminal to perform a function of an IoT security terminal, and an IoT key distribution unit for communicating with the security chip to perform an authentication function according to an authentication protocol is mounted in the central cloud server; the central cloud server comprises a rack housing 2130 on which a plurality of chip boards is mounted, the rack housing 2130 comprises a fixed frame 2132 which is a square frame body, a front door 2134 is openably hinged to one side of the fixed frame 2132 at a front surface of the fixed frame 2132, a rear plate 2136 is fixed to a rear surface opposite to the front door 2134, side plates 2138 are fixed to both sides of the fixed frames 2132, respectively, a bottom plate 2140 is fixed to a bottom surface of the fixed frame 2132, a top plate 2142 is fixed to a ceiling opposite to the bottom plate 2140, air suction holes 2138a having a square slit shape are formed at both side plates 2138, respectively, a filter 2138b is mounted in the air suction hole 2138a, and an indirect cooling unit 2150 is installed at a top surface of the top plate 2142, the indirect cooling unit 2150 comprises a suction chamber 2152 having a square box shape of which a lower portion is open communicating with the rack housing 2130 through the top plate 2142, a blowing pipe 2154 of which a lower end having a hook shape is inserted through a center top surface of the suction chamber 2152, a blowing fan 2156 installed at a top end of the blowing pipe 2154, an exhaust hole 2160 formed at a hook type horizontal portion 2158 of the blowing pipe 2154, and a plurality of discharge holes 2162 formed at a top surface of a rear chamber 2152 on a position corresponding to the exhaust hole 2160; a plurality of heat radiation fins 2170 are further formed at inner surfaces of the front door 2134 and the side plate 2138, and a heat radiation groove 2172 is recessed at a position corresponding to a heat radiation fin 2170 of an outer surface; an extinguisher unit 3000 is further installed at a ceiling surface of the rack housing 2130, the extinguisher unit 3000 comprises a guide plate 3510 at the ceiling surface 152, bolt holes 3520 for locking a bolts are formed at both sides of the guide plate 3510, a locking member 3530 integrally protrudes from a center of a plate between the bolt holes 3520, a fire extinguisher case 3600 is provided at the locking member 3530 and is inserted in a longitudinal direction of the guide plate 3510 to be assembled and fixed in a sliding scheme, an assembly 3610 protrudes from a top surface of the fire extinguisher case 3600 and is inserted into the locking member 3530 so as not to be separated, an outlet 3620 is formed at an opposite surface of the fire extinguisher case 3600 in a state that a part of the outlet 3620 is open, an empty space is formed inside the fire extinguisher case 3600, a fire extinguishing object receiving member 3630 having a square box shape of which a bottom surface is open, is charged at the empty space of the fire extinguisher case 3600, a fire extinguishing object 3640 is embedded in the fire extinguishing object receiving member 3630, and a net assembly 3650 is fixed to an open bottom surface of the fire extinguishing object receiving member 3630; the net assembly 3650 includes a frame body 3652 having a channel (⊏) shaped section fixed to a front edge of the fire extinguishing object receiving member 3630 and net bodies 3656 adhering and fixed to a top surface and a lower surface of an inner space 3654 of the frame body 3652 to be spaced apart from each other, and an explosion inductive material 3660 is inserted at a space between the net bodies 3656.

The present invention may prevent unauthorized access by reinforcing security of Internet Of Things (IoT) upon smart metering using the IoT as a part of a smart grid and may efficiently controlling power distribution to distribution lines using metering information according to smart metering.

### BRIEF DESCRIPTION OF THE DRAWINGS

FIG. 1 is a block diagram schematically a smart grid system according to the related art;

FIG. 2 is a block diagram schematically illustrating a configuration of a cloud based smart grid system according to the present invention;

FIG. 3 is a block diagram schematically illustrating a central cloud server according to the present invention;

FIG. 4 is a block diagram schematically illustrating a distributed cloud server according to the present invention;

FIG. 5 is a sequence diagram illustrating an embodiment which registers a smart meter and a smart box in a smart metering method according to the present invention;

FIG. 6 is a sequence diagram illustrating an embodiment which collects and provides power information in a smart metering method according to the present invention;

FIG. 7 is a sequence diagram illustrating an embodiment which provides failure generation information of a smart meter and a smart box in a smart metering method according to the present invention;

FIG. 8 is a sequence diagram illustrating an embodiment which controls a smart meter and a smart box in a smart metering method according to the present invention;

FIG. 9 is an exemplary view illustrating a rack housing of a device for controlling power distribution to distribution lines according to the present invention;

FIG. 10 is an exemplary view illustrating an indirect cooling unit applied to the rack housing of FIG. 9;

FIG. 11 is a sectional view illustrating main parts shown in FIG. 9;

FIG. 12 is a pattern diagram illustrating an installation example of a fire extinguishing unit installed inside a rack housing shown in FIG. 9; and

FIG. 13 is a view illustrating the fire extinguisher unit shown in FIG. 12.

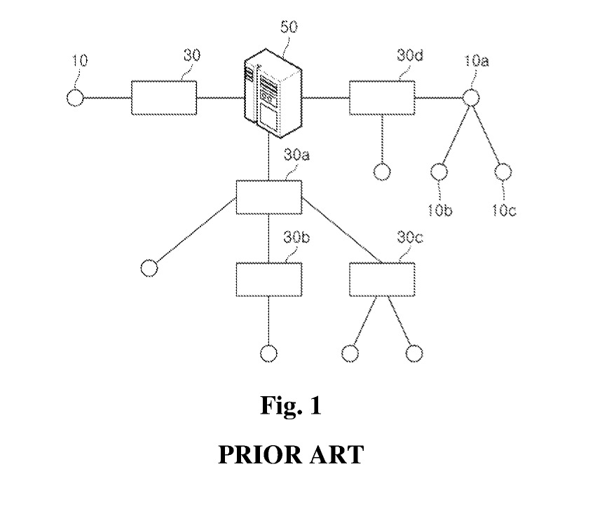

### DESCRIPTION OF EXEMPLARY EMBODIMENTS

Hereinafter, an exemplary embodiment of the present invention will be described in detail with reference to the accompanying drawings.

Various example embodiments will be described more fully hereinafter with reference to the accompanying drawings, in which some example embodiments are shown. The present inventive concept may, however, be embodied in many different forms and should not be construed as limited to the example embodiments set forth herein.

The embodiment may have various modifications, and various embodiments may be provided. Hereinafter, a specific embodiment is illustrated in accompanying drawings and will be described with reference to accompanying drawings. However, the embodiment is not limited to the specific embodiment, but the embodiment includes all modifications, equivalents, and substitutes belonging to the technical scope of the embodiment without departing from the spirit of the embodiment.

The present invention uses a part of Korean Patent number 10-1522175 (May 15, 2015) described in the related art. Accordingly, a part of a description is the same as that described in Korean Patent number 10-1522175, and an improved or added configuration in the present invention will be described below.

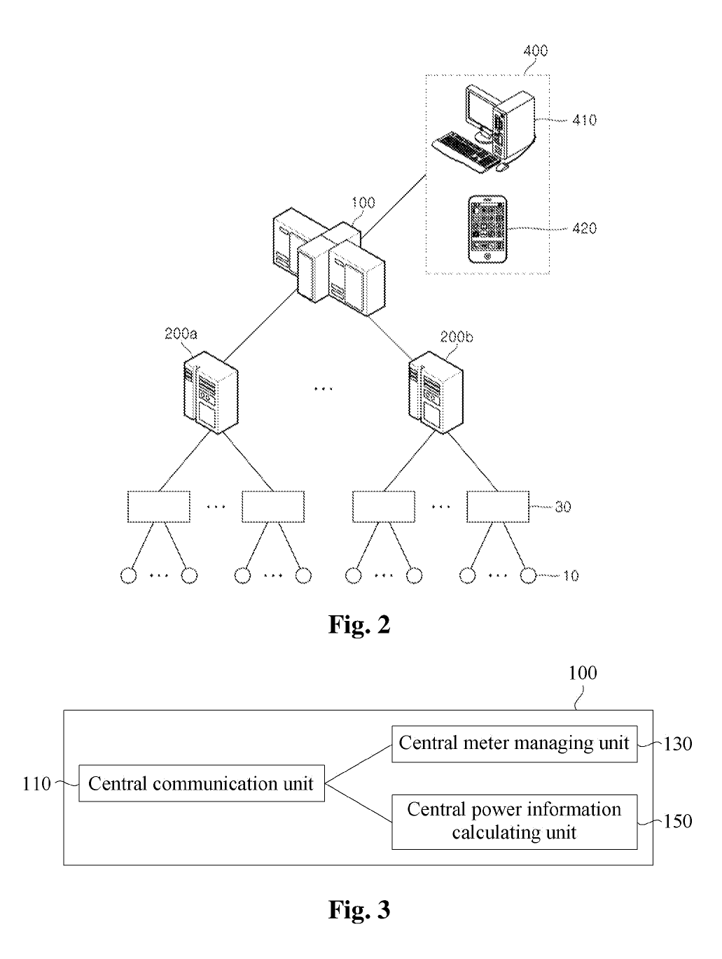

Referring to FIG. 2, a device for controlling power distribution to distribution lines according to the present invention includes distributed cloud servers 200a and 200b for classifying a plurality of smart meters 10 and smart boxes 30 distributed to a plurality of zones into groups by zone to control and manage the groups by zone; and a central cloud server 100 for processing power information in connection with the plurality of smart meters 10 and smart boxes 30 and for controlling the smart meters 10 and smart boxes 30.

Here, the smart meters 10 and the smart boxes 30 distributed to a plurality of zones may be configured by a multi-layered architecture of various forms such as a bus configuration, a tree configuration, and a mesh configuration. Further, the smart meters 10 and the smart boxes 30 may be configured by different types to have different data transmission schemes including power information.

Moreover, the central cloud server 100 groups the smart meters 10 and the smart boxes 30 distributed to a plurality of zones by zone according to an installation zone to allocate distributed cloud servers 200a and 200b of a corresponding zone by zone. Distributed servers 200a and 200b of each corresponding zone store and manage power information of the smart meter 10, and the central cloud server 100 may receive and use power information from the distributed cloud servers 200a and 200b periodically or if necessary.

Furthermore, the central cloud server 100 may determine and select a distributed cloud server which manages a group including a smart meter and a smart box to be controlled among a plurality of distributed cloud servers 200a and 200b in controlling the smart meter and the smart box, and control a corresponding smart meter and smart box in connection with the selected distributed cloud server.

Here, the distribution cloud servers 200a and 200b of the corresponding zone may be located at a zone of the allocated group, more preferably, the distribution cloud servers 200a and 200b may be a cloud server which manages a corresponding zone as a virtual server located at a place other than the zone of the allocated group.

Moreover, the central cloud server 100 may be connected to a plurality of distributed cloud servers 200a and 200b through various networks such as Internet. It is preferred that the central cloud server 100 and the distributed cloud servers 200a and 200b may be located at the same place as a virtual server depending upon situations.

Further, the smart box 30 connected to the smart meter 10 may be connected with the distributed cloud servers 200a and 200b through various networks such as Internet, a power line communication network, or a mobile dedicated line.

A power provider, a smart grid manager, and a power consumer may connect with a central cloud server 100 using a remote access terminal 400 through various networks to receive various power information and to control the smart meter and the smart box. Here, the remote access terminal 400 may be a PC 410 or a mobile phone 420.

As described above, the present invention classifies many smart meters and smart boxes distributed to each zone according to an installed zone, allocates a distributed cloud server by group so that a plurality of cloud servers store and manage a large amount of metering data in a distributed manner. And the central cloud server provides power information in connection with the distributed cloud server to reduce server capacity and simultaneous load applied to the server.

In particular, since the present invention is configured based on a cloud service, consumers or a manager may receive power information and approach through various types of terminal in a desired place at a desired time without temporal and spatial restrictions.

Referring to FIG. 3, a central cloud server 100 includes a central communication unit 110, a central meter managing unit 130, and a central power information calculating unit 150.

In this case, the central communication unit 110 is a communication interface to connect the remote access terminal 400 or a distributed cloud server 200 with a central cloud server 100, and may be connected to various communication networks such as PLC communication, Internet communication, mobile communication, and PSTN.

The central meter managing unit 130 acquires and stores inherent information such as an installation zone and a product type of the smart meters and the smart boxes and groups the smart meters and the smart boxes by zone to allocate a distributed cloud server 200 by group, and registers, controls, and manage the smart meters and the smart boxes in connection with the distributed cloud server 200.

In addition, when a smart meter and a smart box fail, the central meter managing unit 130 analyzes the failure in connection with the distributed cloud server 200 to provide failure information to the remote access terminal 400. The central meter managing unit 130 may recover the occurrence of the failure by controlling a corresponding smart meter and a corresponding smart box in connection with the distributed cloud server 200 based on a failure analysis result or a control signal of the remote access terminal 400.

The central power information calculating unit 150 receives power information stored in the distributed cloud server 200 to provide the power information to the remote access terminal 400 periodically or if necessary. In addition, the central power information calculating unit 150 may provide an integrally analyzed result to the remote access terminal 400.

Here, the central power information calculating unit 150 may provide only power information with respect to one consumer. The central power information calculating unit 150 may integrate power information by zone to provide an analysis result with respect to use of power by zone. In addition, the central power information calculating unit 150 may integrate all power information to provide various analysis information such as an analysis result with respect to power consumption by industry, an analysis result with respect to power consumption by season, and a power consumption pattern analysis result.

Accordingly, excessive load may be prevented so that safety accidents may be prevented by suitably controlling power of a distribution line through the above information.

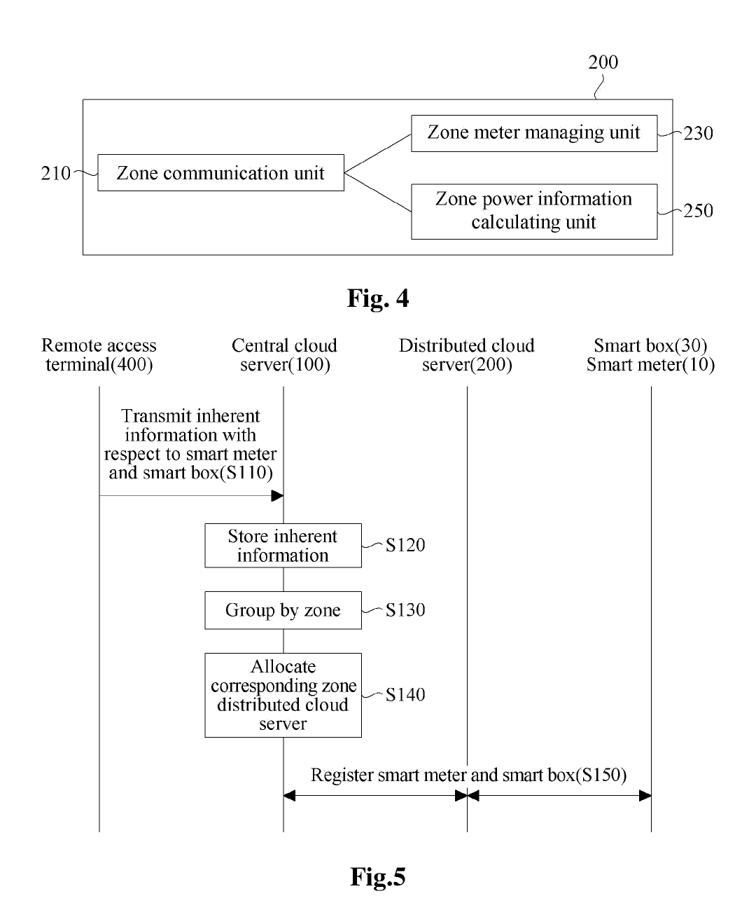

Furthermore, referring to FIG. 4, the distribution cloud server 200 includes a zone communication unit 210, a zone meter managing unit 230, and a zone power information calculating unit 250.

In this case, the zone communication unit 210 is a communication interface to connect a smart box 30 or a central cloud server 100 with a distribution cloud server 200, and may be configured to be connected to various communication networks such as PLC communication, Internet communication, mobile communication, and PSTN.

Here, a plurality of distribution cloud servers 200 may be configured by one or several virtual servers. A plurality of distribution cloud servers located on one virtual server shares one zone communication unit 210 to configure a communication interface through the one zone communication unit 210.

Furthermore, the central cloud server 100 and the distribution cloud server 200 may be configured as one virtual server. In this case, the zone communication unit 210 and the central communication unit 110 may be the same communication interface.

The zone meter managing unit 230 registers, manages, and controls the smart meter 10 and the smart box 30 included in a group of a zone allocated to the distributed cloud server 200. The zone meter managing unit 230 may register the allocated smart meter and smart box and control a corresponding smart meter and smart box according to a control signal from the central cloud server 100.

Furthermore, the zone meter managing unit 230 may set respective product types and data transmission/reception formats based on inherent information on the smart meter 10 and the smart box 30 upon registering the smart meter 10 and the smart box 30.

The zone power information calculating unit 250 collects metering data from a smart meter 10 included in a group of an allocated zone to analyze and store power information, and extracts stored power information to transmit the extracted power information to the central cloud server 100 periodically or if necessary.

Here, the zone power information calculating unit 250 may individually store metering data provided from the smart meter and power information with respect thereto, may analyze and store power information on a predetermined group or the whole zone, and may analyze various use patterns such as by industry, by business category, by season, and by time zone based on power information to store a result.

Further, the zone power information calculating unit 250 receives and collects metering data and state information from the smart meter 10 and the smart box 30. The zone meter managing unit 230 determines whether the smart meter 10 and the smart box 30 fail based on the collected power information. When the smart meter 10 and the smart box 30 fail, the zone meter managing unit 230 transmits failure information to the central cloud server 100.

In addition, by providing an interworking structure between the plurality of distributed cloud servers and the central cloud server, in order to control and manage each smart meter and smart box, there is no need to configure a network suited to respective conditions and to establish a platform and a server for supporting the network. Accordingly, a configuration cost of the smart grid system is reduced and it is easy to expand the system.

The following is a description of a smart metering method through the above device.

Referring to FIG. 5, in order to register the smart meter and the smart box, a manager transmits inherent information on an installation zone and a product type with respect to a smart meter and a smart box to be registered using a remote access terminal 400 (S110).

A central meter managing unit 130 of the central cloud server 100 stores the transmitted inherent information (S120), and groups a plurality of smart meters and smart boxes by zone based on installation zone information included in the inherent information (S130). In a case of newly registered smart meter or smart box in a state that a group by zone is previously classified, based on installation zone information included in the inherent information, the newly registered smart meter or smart box are additionally included in a group of a corresponding zone among groups by preset zone.

Furthermore, the central meter managing unit 130 of the central cloud server 100 selects a distributed cloud server 200 for managing each group to allocate smart meters and smart boxes of a corresponding group to the selected distributed cloud server 200. The central meter managing unit 130 of the central cloud server 100 additionally allocates the newly registered smart meter or smart box to a distributed cloud server 200 for managing a corresponding group.

If a distributed cloud server 200 of a group by zone is selected by the central cloud server 100, the central cloud server 100 registers smart meters and smart boxes in connection with the distributed cloud server 200. In this case, the distributed cloud server 200 sets a product type and a data transmission/reception formation based on unique information of a corresponding smart meter and smart box.

Through a series of procedures, the central cloud server 100 and the distributed cloud server 200 may recognize a smart meter and a smart box by registering the smart meter and the smart box.

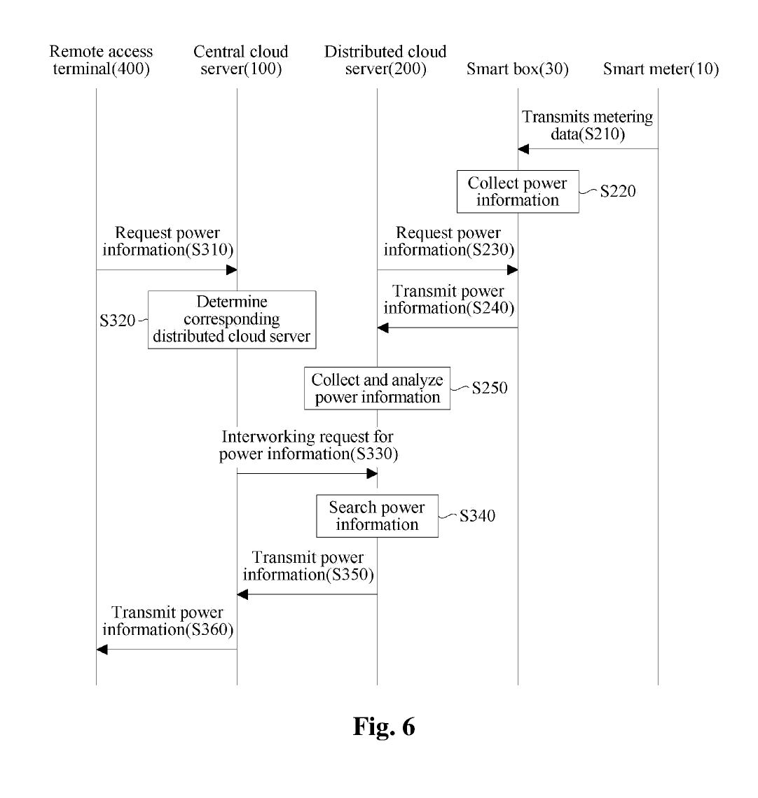

Moreover, in order to collect and provide power information, as shown in FIG. 6, if the smart meter 10 transmits metering data to the smart box 30 (S210), the smart box 30 collects power information including metering data (S220) to transmit the collected power information to the distributed cloud server 200 (S240).

In this case, the smart box 30 may transmit the collected power information according to a power information request (S230) from the distributed cloud server 200 or periodically, or may receive metering data from the smart meter 10 and may simultaneously transmit the metering data to the distributed cloud server 200. A transmission time point of the above power information may be flexibly set according to a situation of a system.

The zone power information calculating unit 250 collects, analyzes, and stores power information provided from the smart box 30 (S250).

Further, if the central cloud server 100 receives the request of power information from the remote access terminal 400 of a manager or a consumer (S310), the central meter managing unit 130 of the central cloud server 100 determines a group including smart meters or smart boxes related to corresponding power information and determines and selects a distributed cloud server 200 which manages a corresponding group (S320), and transmits an interworking request for receiving the power information to the distributed cloud server 200 (S330).

According to the interworking request of the central cloud server 100, the zone power information calculating unit 250 of the distributed cloud server 200 selects and extracts corresponding power information from the stored power information (S340) to transmit the extracted power information to the central cloud server 100 (S350). Here, as described above, the power information provided from the distributed cloud server 200 may include results analyzing various usage patterns by industry, by business category, by season, and by time zone.

The central power information calculating unit 150 of the central cloud server 100 transmits power information provided from the distributed cloud server 200 to the remote access terminal 400 (S360). If necessary, in order to provide various power information to a manager or a consumer, various analysis results may be provided together. Here, as described above, the various analysis results may include information calculating the analysis results with respect to power consumption by industry, an analysis result with respect to power consumption by season, and a power consumption analysis result by integrating all power information.

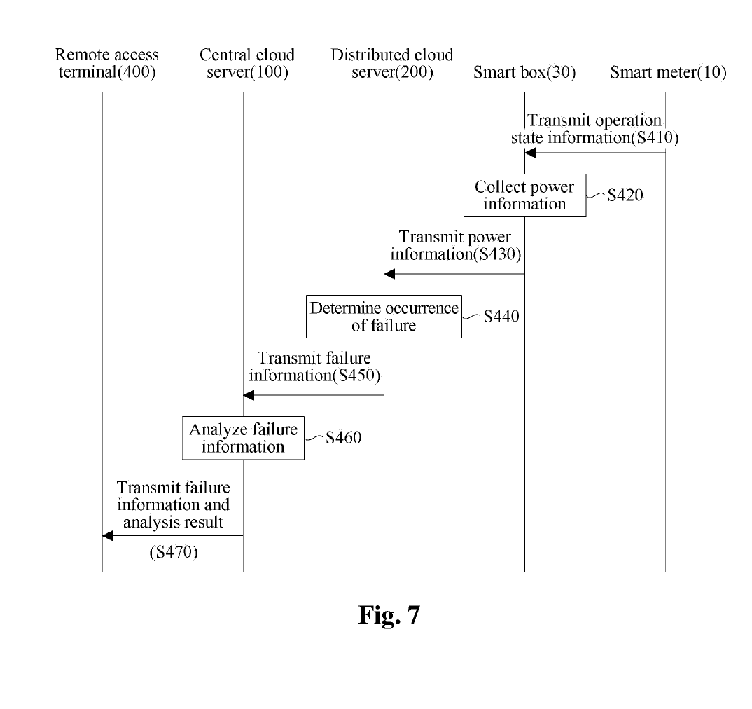

Furthermore, in a case of an example of providing failure occurrence information of the smart meter or the smart box, as shown in FIG. 7, the smart meter 10 transmits operation state information of the smart meter 10 to the smart box 30 periodically or in real time (S410), and the smart box 30 collects power information including state information of the smart meter 10 and state information of the smart box 30 (S420) to transmit the power information to the distributed cloud server 200 (S430).

The zone power information calculating unit 250 of the distributed cloud server 200 collects and stores the power information provided from the smart box 30, and the zone meter managing unit 230 of the distributed cloud server 200 analyzes metering data and state information included in the power information to determine whether the smart meter or the smart box 30 is normally operated. As the analysis result, when it is determined that an operation of the smart meter 10 or the smart box 30 fails (S440), the distributed cloud server 200 transmits error information of a corresponding smart meter or smart box to the central cloud server 100 (S450).

The central meter manager 130 of the central cloud server 100 analyzes failure occurrence situation, a failure content, and a recovery method of the corresponding smart meter or smart box according to the error information from the distributed cloud server 200 to transmit the failure information and an analysis result to a remote access terminal 400 of a manage or a consumer (S470).

Next, the central cloud server 100 may recover a corresponding smart meter or smart box in connection with a corresponding distributed cloud server 200 according to the error analysis result, or may recover the corresponding smart meter or smart box in connection with the corresponding distributed cloud server 200.

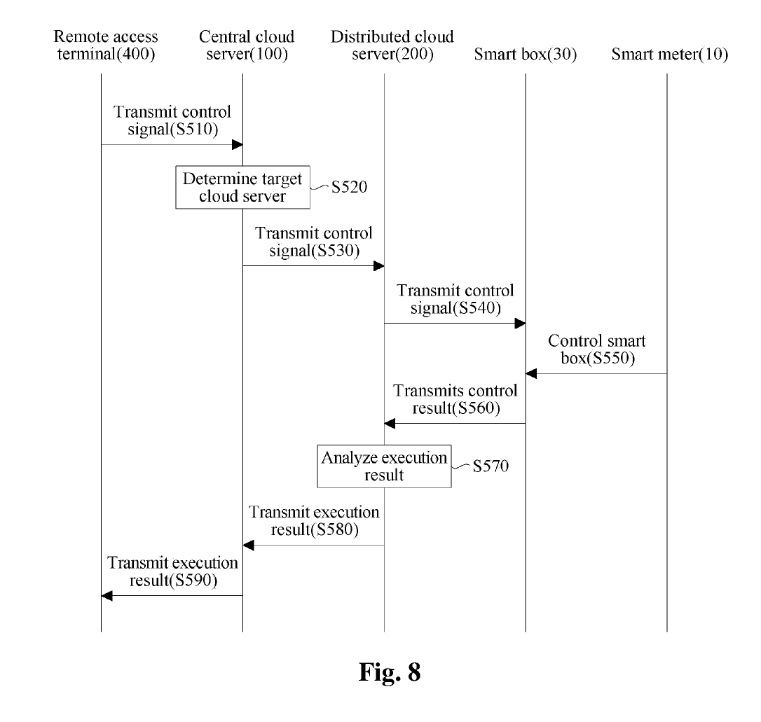

Further, as shown in FIG. 8, a method for controlling a smart meter and a smart box means a method of remotely a corresponding smart meter or smart box through a remote access terminal by a manager or a consumer when failure occurs.

That is, when there is a need to control a specific smart meter 10 or a specific smart box 30, a manager or a consumer accesses a central cloud server 100 by a remote access terminal thereof to transmit a corresponding control signal to the central cloud server 100 (S510).

According to a received control signal from the remote access terminal 400, the central meter managing unit 130 of the central cloud server 100 determines and selects a distributed cloud server 200 being a target managing a group including a smart meter 10 or a smart box 30 to be controlled according to the control signal (S520), and transmits the control signal to the selected target distributed cloud server 200 (S530).

The zone meter managing unit 230 of the distributed cloud server 200 transmits a control signal to a corresponding smart box 30 according to the transmitted control signal (S540). When a control target is a smart box 30, a smart box is controlled according to the control signal (S550). When the control target is a smart meter 10, the smart box 30 transmits a control signal to the smart meter 10 so that the smart meter 10 is controlled (S550).

The smart box 30 transmits a control execution result to the distributed cloud server 200 (S560). The zone meter managing unit 230 of the distributed cloud server 200 analyzes a control result (S570) to determine whether a control operation with respect to the smart box or the smart meter is successfully performed.

Here, as a control signal is transmitted to the smart box or the smart meter so that a smart box or a smart meter is operated according to the control signal, a zone meter managing unit 230 of the distributed cloud server 200 substantially operates a corresponding smart box or smart meter based on the control signal. An operation result of the smart box or the smart meter according to the control signal allows the zone meter managing unit 230 of the distributed cloud server 200 to determine the signal transmission according to operation of the smart box or the smart meter.

Through the above procedure, the distributed cloud server 200 executes an operation control of the smart box 30 or the smart meter 10 and analyzes and transmits the operation control execution result to the central cloud server 100 (S580). The central cloud server 100 transmits the operation control execution result from the distributed cloud server 200 to the remote access terminal 400 (S590) to be provided to a manager or a user.

According to the present invention, a consumer and a manger accesses a central cloud server by a remote access terminal thereof and a central cloud server performs a device control function based on various power information in connection with a corresponding distributed cloud server to efficiently provide various power information and error occurrence information and so that a consumer and a manager may perform various control functions with respect to a corresponding device.

The present invention is based on the above configuration. When the above device is implemented, the remote access terminal 400 uses an IoT security terminal, and the IoT security terminal includes a remote access terminal 400 on which a security chip is mounted.

In this case, the security chip performs a function of Reverse Engineer Protection, SHA256, AES128, and uses a security chip used in an information communication field such as a forgery function, a firmware level upgrade copy protection function, a secure boot function for protecting a kernel image upon booting, and a security key management function.

Further, the central cloud server 100 should additionally include a function of an IoT key distribution server. Accordingly, an IoT key distribution unit (not shown) is further mounted on the central cloud server 100.

The IoT key distribution unit implements key distribution and authentication protocol between a terminal-a server in connection with the security chip.

To this end, an algorithm capable of processing SHA-512/256, RSA128, MAC (MessageAuthentication Code), Random Number Generator, and a symmetric key scheme in the IoT key distribution unit, and the IoT key distribution unit include a flow with respect to key discrepancy processing.

Further, it is preferred that the IoT key distribution unit is designed to be achieved by an IoT authentication protocol associated with authentication. Only authorized persons access the IoT key distribution unit through an IoT security terminal.

In this case, the IoT security terminal is designed that allows authentication between a Main Control Unit (MCU) and a security chip of the terminal by au authentication protocol. When a security chip is mounted, it is determined whether the security is normal. Only a normal security chip is mounted. Further, when the IoT security terminal requests access to an IoT key distribution unit of the central cloud server 100, there is an authentication protocol between each other. In this case, it is preferred that the authentication protocol is implemented by a transaction interlock OTP authentication scheme instead of an existing OTP authentication scheme.

When a smart phone is used, a compatible protocol for a security application or a smart phone application instead of a security chip may be used.

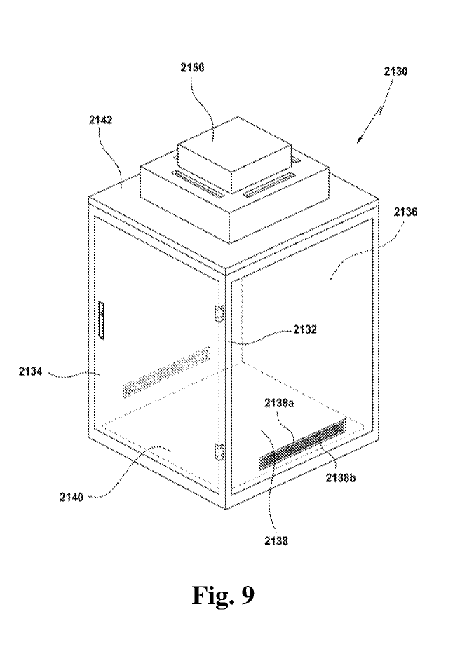

In addition, in a central cloud server 100 of a device according to the present invention, a plurality of chip boards is mounted on a server rack, and the server rack is mounted in a rack housing 2130 which is illustrated in FIG. 9 to FIG. 11.

However, since chip boards mounted on the server rack generate much heat during processing, if the chip boards are not suitably cooled, the chip boards are easily degraded so that a server is shutdown. In this way, the chip boards become inability to control so that a cost and a time for recovery are increased.

Accordingly, in order to prevent such a phenomenon, there is a need to cool an inside of the rack housing 2130. Since a general direct blowing cooling system causes short-circuit according to dust scattering to cause an additional safety accidents, an indirect blowing system (indirect heat exchanger) is applied.

However, since the indirect cooling system itself is a facility having a high cost large size, an early facility cost is significantly increased so that it is considerably difficult to implement the indirect cooling system.

Accordingly, the present invention is configured to efficiently present the same effect by using an indirect cooling unit having a very simple structure.

For example, the rack housing 2130 includes a fixed frame 2132 being a square frame. A front door 2134 is openably hinged to one side of the fixed frame 2132 at a front surface of the fixed frame 2131. A rear plate 2136 is fixed to a rear surface opposite to the front door 2134. Side plates 2138 are fixed to both sides of the fixed frame 2132, respectively. A bottom plate 2140 is fixed to a bottom surface of the fixed frame 2132. A top plate 2142 is fixed to a ceiling opposite to the bottom plate 2140.

Furthermore, both side plates 2138 are formed therein with air suction holes 2138a having a square slit shape, and filters 2138b are embedded in the air suction holes 2138a, respectively.

Accordingly, external air is introduced into a rack housing 2130 in a filtered state.

An indirect cooling unit 2150 is installed at a top surface of the top plate 2142.

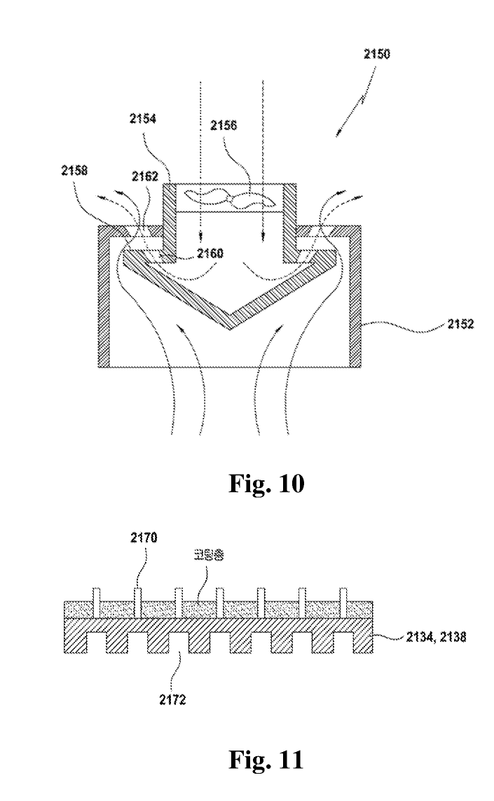

As shown in a sectional view of main parts enlarged in FIG. 10, the indirect cooling unit 2150 includes a suction chamber 2152 having a square box shape of which a lower portion communicates with the rack housing 2130 through the top plate 2142; a blowing pipe 2154 including a bottom end having a hook shape inserted through a top center of the suction chamber 2152; a blowing fan 2156 installed at a top end of the blowing pipe 2154; an exhaust hole 2160 formed at a hook type horizontal portion 2158 of the blowing pipe 2154; and a plurality of discharge holes 2162 formed at a top surface of a rear chamber 2152 at a position corresponding to the exhaust hole 2162.

Accordingly, if the blowing fan 2156 is operated, external air is introduced into the blowing pipe 2154 and then is discharged through the exhaust hole 2160 and the discharge holes 2162.

That is, the introduced external air is not supplied into the rack housing 2130 but a direction of the introduced external air is changed and then the external air is again discharged to the outside.

During the above procedure, sound pressure is generated inside the suction chamber 2152, in particular, around the discharge hole 2162. Because of suction pressure due to the sound pressure, internal air distributed in a lower space of the suction chamber 2152 is escaped by a kind of Venturi effect so that air heated inside the rack housing 2130 is discharged to the outside.

Accordingly, sound pressure is fully formed inside the rack housing 2130. Fresh cold external air is introduced into the rack housing 2130 through a filter 2138b and the suction hole 2138a so that dust is created inside the rack housing 2130 or is naturally cooled not to be scattered.

That is, since a general cooling structure introduces external air through a blowing fan 2156 and directly sprays the external air into the rack housing 2130 to directly cool the rack housing 2130, heavy dust is generated inside the rack housing 2130 due to blowing pressure during the above procedure. The dust adheres to a main terminal of each chip board. In some cases, spark due to static electricity is generated so that the main terminal of each chip board is open.

However, since the present invention has an indirect blowing scheme fully excluding the above situation, that is, an indirect cooling structure, the present invention may cool the rack housing 2130 without generating dust inside the rack housing 2130.

In addition, since a coating layer having heat resistance and latent is formed at an inner surface of a front door 2134, a side plate 2138, a bottom plate 2140, and a rear plate 2136 configuring the rack housing 2130, if the rack housing 2130 has a latent function, that is, a supplementary heat function which has partial heat upon generation of heat and emits the heat at a cold time, the rack housing 2130 is more stably operated so that degradation of a board may be prevented to the highest degree. It is more preferred to configure the rack housing 2130 to contribute to stability preventing short-circuit by having an anti-static function.

The coating layer is formed by adding sodium silicate of 8 weight part, oxycarboxylate of 2.5 weight part, citronella oil of 1.5 weight part, micro capsulated polypropylene yarn of 3 weight part of 0.1 μm length, paraffin wax of 5 weight part, polyoxyethylene of 4 weight part, propylene glycol of 3 weight part, N-ethyl gabazol methacrylate of 2.5 weight part, sepiolite of 3 weight part, melamine cyanate of 2.5 weight part, tetraisopropyltitanate of 2.5 weight part, and Mica 1.5 weight part with respect to acryl resin 100 weight parts, to a mixture of acryl resin 80 weight % and methylpentene polymer resin 80 weight % and spray coating in a heated state of 50° C. to 60° C.

Here, the mixture is heated at the above temperature range for the purpose of maintaining uniform dispersibility and stability while increasing liquidity. In this case, the acryl resin is added for the purpose of maximizing adhesion. Since the methylpentene polymer resin has low viscosity and excellent liquidity, is easy to be coated, has a very high melting point with 235° C. to represent excellent mechanical strength at a high temperature, the methylpentene polymer resin is added in order to reinforce the heat stability.

Further, the sodium silicates are added to reinforce the heat stability by forming a film through gelation.

The oxycarboxylate is added to improve the strength by reducing a moisture content of a material to reduce an air gap.

In general, the citronella oil is added to increase repulsion. In the present invention, the citronella oil is added to control viscosity of inorganic powers and to improve mix of the inorganic powers as well as the above function.

Furthermore, in order to implement heat retention in urethane resin, micro capsulated polypropylene yarn of 0.1 μm length may be further added by a Wurster method.

In addition, the paraffin wax is a phase change material having a phase change temperature change band in the range of 20° C. to 50° C. Since the paraffin wax performs a heat retention function for a long time by accumulating latent heat to prevent a temperature from being reduced upon heating and performs a heating function by radiating the latent heat upon cooling, the paraffin wax is added to use the latent heat in the present invention.

The polyoxyethylene is a type of polyether to polymerize oxidized ethylene using cation catalyst. In the present invention, the polyoxyethylene is add to be dissolved in water and forms a film using textile and paper to prevent static electricity from being generated.

Moreover, since the propylene glycol has a moisture absorption property but has no volatility to be stable against heat and light, the propylene glycol is used as solvent to be mixed with water by melting resin and is added to prevent mold from being bred on a surface.

Moreover, the N-ethyl gabazol methacrylate is added to prevent crack from occurring by stabilizing a coating layer while reinforcing transparency.

Furthermore, the sepiolite is called meerschaum which is a transformer having a circular pipe shape and is added to improve dispersion stability and uniform dispersion of a resin composition.

Further, the melamine cyanate is added to reinforce heat resistance. Moreover, the tetraisopropyltitanate is a coupling material having an organic titanate structure and is added to increase durability and heat resistance by reinforcing interfacial adhesion between polymer resin and an inorganic material. The Mica is a type of a silicate mineral and is crushed to the size of 0.1 μm to 0.2 μm to be used, and is added to improve surface strength and heat resistance due to hard property.

The configuration of the coating layer may prevent a chip board from being degraded using heat stability and a latent heat property.

In addition, in order to confirm whether the coating layer represents a latent heat property, that is, heat retention, after an iron plate sample having no coating layer and an iron plate sample having the coating layer are prepared, a latent heat property is confirmed according to JIS C 6802-1997.

As the measurement result, the iron plate sample having the coating layer has the latent heat of 46 W/m.k, and the iron plate sample having no coating layer has the latent heat of 58 W/m.k. That is, it is confirmed that the iron plate sample having the coating layer represents the latent heat property (heat absorption power).

Further, in order to further reinforce the heat radiation property, as illustrated in FIG. 11, a plurality of heat radiation fins 2170 are further formed through an inner coating surface of the front door 2134 and the side plate 2138. A heat radiation groove 2172 may be recessed at an outer corresponding position, in other words, a position corresponding to the heat radiation fin 2170.

That is, after the heat radiation fins 2170 and the heat radiation groove 2172 are formed, a coating layer is formed by spraying a coating liquid.

In this case, the heat radiation fin 2170 further protrudes in comparison with a surface of the coating layer. Through the above, a heat radiation effect may be increased. In a case of the heat radiation groove 2172, the heat radiation effect may be improved by increasing a contact area with external air to increase a stayed area.

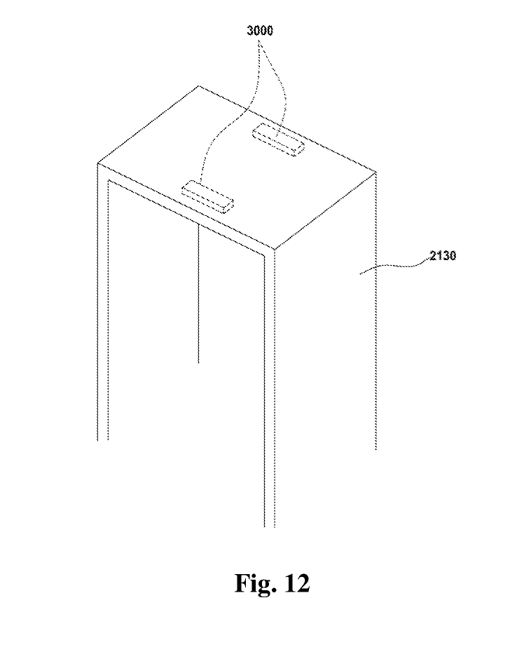

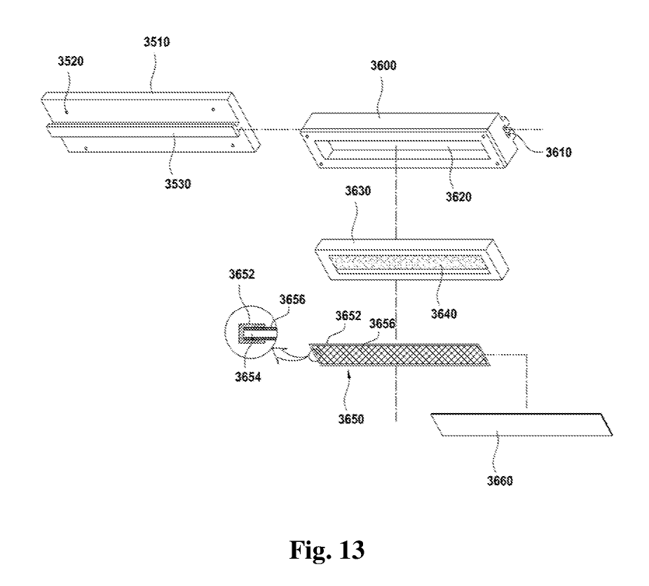

In addition, as illustrated in FIG. 12 and FIG. 13, a fire extinguisher unit 3000 may be further installed at both sides of a position not to interfere with the indirect cooling unit 2150 at an inner ceiling surface of the rack housing 2130.

To this end, a guide plate 3510 is provided at a ceiling surface of the rack housing 2130. Bolt holes 3520 for locking a bolt are formed at both sides of the guide plate 3510. A locking member 3530 integrally protrudes from a center of a plate between the bolt holes 3520.

Further, a fire extinguisher case 3600 is provided at the locking member 3530 and is inserted in a longitudinal direction of the guide plate 3510 to be assembled and fixed in a sliding scheme. An assembly 3610 protrudes from a top surface of the fire extinguisher case 3600 and is inserted into the locking member 3530 not to be separated. An outlet 3620 is formed at an opposite surface of the fire extinguisher case 3600 in a state that a part of the outlet 3620 is open. An empty space is formed inside the fire extinguisher case 3600.

In particular, a fire extinguishing object receiving member 3630 having a square box shape of which a bottom surface is open, is charged at the empty space of the fire extinguisher case 3600. A fire extinguishing object 3640 is embedded in the fire extinguishing object receiving member 3630.

Further, a net assembly 3650 is fixed to an open bottom surface of the fire extinguishing object receiving member 3630. The net assembly 3650 includes a frame body 3650 having a channel (⊏) shaped section fixed to a front edge of the fire extinguishing object receiving member 3630 and net bodies 3656 adhering and fixed to a top surface and a lower surface of an inner space 3654 of the frame body 3652 to be spaced apart from each other.

In addition, an explosion inductive material 3660 is inserted at a space between the net bodies 3656.

In this case, the explosion inductive material 3660 is a structure where a first sheet to which potassium chlorate is attached faces a second sheet to which red phosphorus is attached while being interposed a thin paper therebetween.

Here, since the potassium chlorate is water-soluble, it is preferred that the potassium chlorate is dissolved in water to be sprayed on the first sheet to coat with a predetermined thickness. Since the red phosphorus is insoluble, the red phosphorus may be configured to adhere by spreading a solid power before the second sheet is solidized. The first and second sheets are configured by making polyurethane resin as sheet.

Accordingly, if high temperature heat is generated inside the rack housing 2130 so that paper interposed between the first and second sheets is burnt, the first and second sheets are attached to each other. At this moment, the potassium chlorate extremely reacts with the red phosphorus to explode, and the explosion power is applied to downward and upward directions, the extinguishing object 3640 received in the fire extinguishing object receiving member 3630 is scattered through the outlet 3620 of the fire extinguisher case 3600 by the explosion power applied to the upward direction to extinguish an inside of the rack housing 2130.

In this case, the extinguishing object 3640 may be received in a scissile thin vinyl.

Furthermore, the extinguishing object 3640 include Terra abla powder of 15 weight %, coffee bean powder of 5 weight %, antimony tin compound of 5 weight %, magnesium carbonate of 15 weight %, sodium carbonate of 15 weight %, methylsiliconate of 5 weight %, clay powder of 10 weight %, monobasic ammonium phosphate of 10 weight %, zirconium of 5 weight %, mullite of 5 weight %, expandable graphite of 5 weight %, and a mixture 5 weight % of sodium oxide (Na₂O) and potassium oxide (K₂O) mixed with a weight ratio of 1:1.

In this case, it is preferred that the Terra abla is an acid Terra abla. Since the Terra abla represents strong adsorption and absorbs peripheral oxygen by high temperature crystallization, the Terra abla is useful to extinguish fire.

Moreover, the coffee bean powder blocks human body harmfulness up fire by collecting smell to block harmful gas.

In addition, the antimony tin compound extinguishes a fire through heat blocking to prevent the fire from being spread to a periphery.

Moreover, the magnesium carbonate is added for a heat blocking effect as a strong heat spreader.

Furthermore, the sodium carbonate is added to choke-extinguish by strongly generating carbon dioxide and nitrogen.

Further, the methylsiliconate is added to absorb some of generated carbon dioxide and convert carbon dioxide into a mucus silicon to improve choke-distinguishing.

In addition, the clay is a representative extinguishing material.

The monobasic ammonium phosphate is useful to choke-extinguish by covering flame through generating ammonia being incombustible gas and vapor.

In addition, the zirconium is added to be combined with oxygen in air upon the occurrence of fire to form a protection film including oxide and nitrogen, thereby increasing fire resistance and flammability.

Moreover, the mullite has a very high melting point to be used to reinforce refractory in an extinguishing operation.

Since the expandable graphite has a graphite layered structure, if an atom or a small molecule are inserted between layers and heat is applied to the expandable graphite, the expandable graphite is separated like an accordion to reinforce fire extinguishing property using an expanded phenomenon of particles several hundredfold.

Further, the sodium oxide (Na₂O) and potassium oxide (K₂O) are efficient additive use upon vitrification reaction. Since the sodium oxide (Na₂O) has dehydration property and potassium oxide (K₂O) has moisture absorption property, the sodium oxide (Na₂O) and potassium oxide (K₂O) are suitably mixed and used. Self-extinguishing property is reinforced by using mixture of a weight ratio of 1:1.

By using the configured extinguishing object, early suppression is possible upon the occurrence of fire so that the fire is prevented from being spread and human injury and property damage may be reduced.

In the above exemplary systems, although the methods have been described on the basis of the flowcharts using a series of the steps or blocks, the present invention is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present invention.

What is claimed is:

1. A device for controlling power distribution to distribution lines, the device comprising
a distributed cloud server for receiving metering data from at least one smart meter and at least one smart meter distributed to a preset zone to collect and store power information, and for controlling and managing the smart meter and the smart box; and
a central cloud server for classifying a plurality of smart meters and a plurality of smart meters into a group by zone according to an installation zone of the smart meters and the smart boxes to allocate the distributed cloud server to the group by zone, for registering, controlling, and managing the smart meters and the smart boxes in connection with the distributed cloud server, for analyzing the power information of the distributed cloud server to provide the power information and an analysis result to a remote access terminal, and for receiving a control signal with respect to the smart meter or the smart box from the remote access terminal to control the smart meter or the smart box through a distributed cloud server for managing a smart meter or a smart box which is a control target,
wherein a security chip is mounted in the remote access terminal to perform a function of an IoT security terminal, and an IoT key distribution unit for communicating with the security chip to perform an authentication function according to an authentication protocol is mounted in the central cloud server;
the central cloud server comprises a rack housing 2130 on which a plurality of chip boards is mounted, the rack housing 2130 comprises a fixed frame 2132 which is a square frame body, a front door 2134 is openably hinged to one side of the fixed frame 2132 at a front surface of the fixed frame 2132, a rear plate 2136 is fixed to a rear surface opposite to the front door 2134, side plates 2138 are fixed to both sides of the fixed frames 2132, respectively, a bottom plate 2140 is fixed to a bottom surface of the fixed frame 2132, a top plate 2142 is fixed to a ceiling opposite to the bottom plate 2140, air suction holes 2138a having a square slit shape are formed at both side plates 2138, respectively, a filter 2138b is mounted in the air suction hole 2138a, and an indirect cooling unit 2150 is installed at a top surface of the top plate 2142,
the indirect cooling unit 2150 comprises a suction chamber 2152 having a square box shape of which a lower portion is open communicating with the rack housing 2130 through the top plate 2142, a blowing pipe 2154 of which a lower end having a hook shape is inserted through a center top surface of the suction chamber 2152, a blowing fan 2156 installed at a top end of the blowing pipe 2154, an exhaust hole 2160 formed at a hook type horizontal portion 2158 of the blowing pipe 2154, and a plurality of discharge holes 2162 formed at a top surface of a rear chamber 2152 on a position corresponding to the exhaust hole 2160;
a plurality of heat radiation fins 2170 are further formed at inner surfaces of the front door 2134 and the side plate 2138, and a heat radiation groove 2172 is recessed at a position corresponding to the heat radiation fin 2170 of an outer surface;
an extinguisher unit 3000 is further installed at a ceiling surface of the rack housing 2130, the extinguisher unit 3000 comprises a guide plate 3510 at the ceiling surface 152, bolt holes 3520 for locking a bolt are formed at both sides of the guide plate 3510, a locking member 3530 integrally protrudes from a center of a plate between the bolt holes 3520, a fire extinguisher case 3600 is provided at the locking member 3530 and is inserted in a longitudinal direction of the guide plate 3510 to be assembled and fixed in a sliding scheme, an assembly 3610 protrudes from a top surface of the fire extinguisher case 3600 and is inserted into the locking member 3530 so as not to be separated, an outlet 3620 is formed at an opposite surface of the fire extinguisher case 3600 in a state that a part of the outlet 3620 is open, an empty space is formed inside the fire extinguisher case 3600, a fire extinguishing object receiving member 3630 having a square box shape of which a bottom surface is open, is charged at the empty space of the fire extinguisher case 3600, a fire extinguishing object 3640 is embedded in the fire extinguishing object receiving member 3630, and a net assembly 3650 is fixed to an open bottom surface of the fire extinguishing object receiving member 3630;
the net assembly 3650 comprises a frame body 3650 having a channel (⊏) shaped section fixed to a front edge of the fire extinguishing object receiving member 3630 and net bodies 3656 adhering and fixed to a top surface and a lower surface of an inner space 3654 of the frame body 3652 to be spaced apart from each other, and
an explosion inductive material 3660 is inserted at a space between the net bodies 3656.
